(19) United States
(12) Patent Application Publication
(10) Pub. No.: US 2010/0170289 A1
(43) Pub. Date: Jul. 8, 2010

(54) System and Method for Seamless Imaging of Appliance Interiors

(75) Inventor: Dominic Graziano, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/349,364

(22) Filed: Jan. 6, 2009

(51) Int. Cl. F25D 23/02; H04N 7/18

(52) U.S. Cl. 62/449; 348/159; 348/E07.085

(57) ABSTRACT

A system of seamless imaging for appliance interiors includes a display integrated with or otherwise connected to the exterior of an appliance door, such as a refrigerator door. The display may be electronically connected to a camera matrix located on the interior of the appliance door. In one embodiment, the camera matrix is designed to provide an overlapping field of view for seamless viewing of the appliance's interior when the appliance's door is otherwise closed. In another embodiment, the display may cover most or substantially all of the exterior of an appliance door and may have integrated touchscreen technology. Such display may also provide a user interface for accessing and viewing Internet and/or broadcast content on the exterior of the appliance door.

### FIELD OF THE INVENTION

The present invention relates in general to imaging the interior of appliances, such as refrigerators, and more particularly to providing a seamless image of appliance interiors using a camera grid.

### BACKGROUND

The prior art has recognized that it would be beneficial for a user to be able to see into an appliance, such as a refrigerator, without having to open the door. For example, in U.S. Publication No. 2006/0096303 a refrigerator system is disclosed in which a person can view an on-screen image of some of the contents of the refrigerator without having to open the refrigerator door. This is achieved by placing a camera inside the refrigerator and linking it to a display that is attached to the exterior of the refrigerator. This is intended to limit the amount of energy lost by having to open the refrigerator door to view the refrigerator's contents.

However, this prior art approach suffers from the fact that it does not provide a complete and accurate view of the refrigerator's contents. In particular, refrigerators tend to contain numerous items which can obstruct the camera's view of other, smaller items. Additionally, refrigerators tend to have shelving which also creates an obstacle to the camera's view. Thus, only a very limited view of the refrigerator's contents are currently provided by prior art systems.

Some prior art references, such as U.S. Publication No. 2006/0096303, have recognized the possibility of using multiple cameras to obtain a better view. While this may improve visibility somewhat, the fact is that the refrigerator's contents may be moved around and the position of the shelves may be adjusted. Thus, it is impossible to predict where such cameras should be placed ahead of time since it is impossible to know which views will not be obstructed.

However, more than that, the user will have to somehow switch between different camera angles until he or she finds a satisfactory view. And even then, in order to make a fully informed choice about what item(s) to take the user will have to try to recall the other items seen from previous camera angles. This makes the process very laborious and even impractical.

Additionally, all such prior art solutions involve the use of an external display that detracts from the aesthetic appeal of the refrigerator's exterior.

As such, what is needed is a system and method for providing seamless imaging of the interior of appliances which does not suffer from one or more of the aforementioned drawbacks.

### BRIEF SUMMARY OF THE INVENTION

Disclosed and claimed herein are systems and methods for providing seamless imaging of appliance interiors. In one embodiment, a system comprises an appliance, a camera matrix disposed on at least one interior surface of the appliance, where the camera matrix includes a plurality of electrically interconnected cameras. The system further includes a display disposed on an exterior surface of the appliance, and a processor electrically connected to the camera matrix and the display. In one embodiment the processor is adapted to receive individual image data from the plurality of electrically interconnected cameras, generate combined image data from said received individual image data, and provide combined image data to the display.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A depicts a perspective view of an appliance configured in accordance with one embodiment of the invention;

FIG. 1B depicts a partial cut-away view of an appliance configured in accordance with another embodiment of the invention;

FIG. 2 depicts a perspective view of the appliance of FIG. 1A in a partially closed position with hidden objects shown in dotted lines;

FIG. 3 is a block diagram of a system comprised of various components utilized in one embodiment of the invention; and

FIGS. 4A-4C depict various embodiments of imagery being displayed on the exterior of the appliance configured in accordance with the principles of the invention.

### DETAILED DESCRIPTION OF EXEMPLARY EMBODIMENTS

### Disclosure Overview

The disclosure relates to providing a system of seamless imaging for appliance interiors. In one embodiment, a display is integrated with or otherwise connected to the exterior of an appliance door, such as a refrigerator door. The display is electronically connected to a camera matrix located on the interior of the appliance door. In one embodiment, the camera matrix is designed to provide an overlapping field of view (FOV) for seamless viewing of the appliance's interior when the appliance's door is otherwise closed.

Another aspect of the disclosure relates to a display covering most (or substantially all) of the exterior of an appliance door on which desired imagery may be displayed, such as picture data, animation, patterns, video, etc. In one embodiment, the display may include touchscreen technology. In another embodiment, the display may similarly provide a user interface for accessing and viewing Internet and/or broadcast content on the exterior of the appliance door.

While the present disclosure is provided largely with reference to refrigerators, it should equally be appreciated that the principles of the invention are equally applicable to other appliances.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

### Exemplary Embodiments

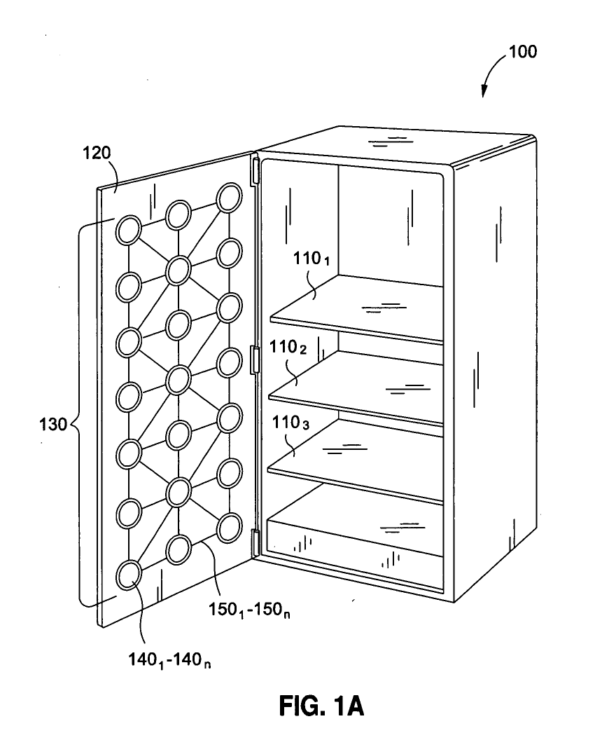

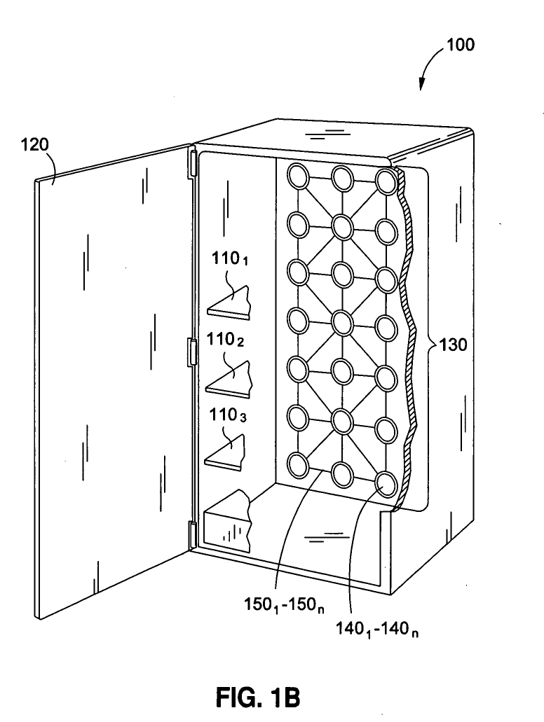

Referring now to FIG. 1A, depicted is one embodiment of a refrigerator 100 configured to provide seamless imaging of its interior. As shown, refrigerator 100 optionally having a number of shelves 110₁-110₃. Such shelves 110₁-110₃ would tend to block the view of any prior art implementation. To that end, the refrigerator door 120 is equipped with a camera matrix 130 which is adapted to provide a complete and seamless view of the contents of the refrigerator when the refrigerator door 120 is in the closed position. As shown in FIG. 1A, the camera matrix 130 is comprised of a plurality of individual cameras 140₁-140ₙ, which may be electrically interconnected via connections 150₁-150ₙ. The plurality of individual cameras 140₁-140ₙ may be based on Charged Control Device (CCD) technology, 3CCD technology, Complementary metal-oxide-semiconductor (CMOS) technology, or any other camera technology otherwise capable of imaging the interior of an appliance. While connections 150₁-150ₙ are visible in the embodiment of FIG. 1A, in another embodiment such connections may be housed within the door 120.

The camera matrix 130 may be configured with overlapping field of view FOV for seamless viewing. The overlapping FOV may be provided by spacing and orienting the lens of each of the plurality of individual cameras 140₁-140ₙ as a function of the inner dimensions of the refrigerator 100. As will be described in more detail below, one or more digital signal processors may be used to stitch together the individual images from the plurality of individual cameras 140₁-140ₙ to provide a single, complete view of the refrigerator's interior.

Depending on the type of camera technology used, it should further be appreciated that the plurality of individual cameras 140₁-140ₙ may require a light source in order to optimally perform. To that end, in one embodiment one or more light sources (e.g., light bulbs) may be incorporated into the interior of the refrigerator so as to provide adequate illumination therein. Alternatively, the refrigerator's 100 standard light source (i.e., the light bulb activated when the refrigerator door 120 is opened) may be used.

Referring now to FIG. 1B, depicted is another embodiment of the refrigerator 100 of FIG. 1A in which another camera matrix 130 is located against the rear inner wall of the refrigerator 100. For clarity, FIG. 1B shows a partial cut-away view of the refrigerator 100. This design may be advantageous for viewing items that may otherwise be obstructed from a frontal-viewing angle. While in one embodiment camera matrices 130 may be located along both the rear wall as well as the inner refrigerator door 120, it should be appreciated that a single camera matrix 130 may be located along either the rear wall or the inner refrigerator door 120. Similarly, it should be appreciated that additional camera matrices may be located along one or both of the refrigerator inner side walls.

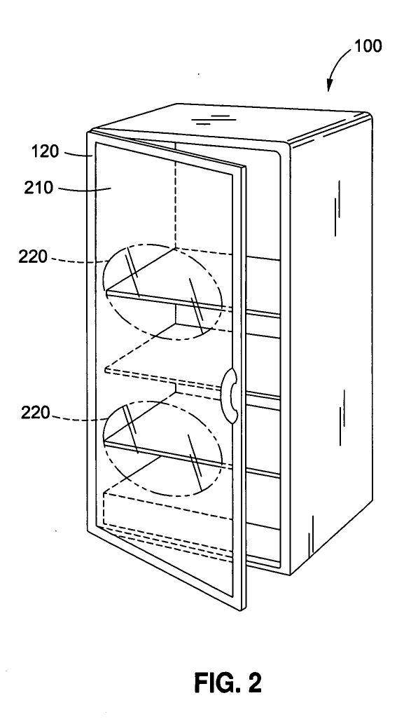

Referring now to FIG. 2, depicted is the refrigerator 100 with its door 120 in a partially closed position and hidden (or non-visible) objects depicted with dotted lines. The orientation of FIG. 2 shows how a display 210 has been integrated with or otherwise connected to the exterior of the refrigerator door 120. In one embodiment, the display 210 may comprise a touchscreen and/or may be an Organic Light Emitting Diode (OLED) display. Additionally, the display 210 is depicted as covering substantially all of the exterior of the refrigerator door 120. However, it should be appreciated that the display 210 may similarly extend over most of the refrigerator door (e.g., between 50% and 95% of the refrigerator door 120).

When the refrigerator door 120 is in the closed (or partially closed position), the display 210 is configured to receive and display the image data from the camera matrix 130 (not shown). In this fashion, a complete and seamless visual representation of the refrigerator's interior is provided. By way of example, areas 220 depict how the invention may look to a user in one embodiment. In particular, areas 220 may provide a “see through” effect since the images in areas 220 may depict the corresponding portions of the refrigerator interior. In another embodiment, area 200 may cover the entire display (and hence the entire front of the refrigerator), and thus appear to a user that there is no door on the front of the refrigerator at all. This “see through” effect may be provided by the overlapping FOV data that the camera matrix 130 provides to the display 210, which may extend across substantially all or most of the exterior of the refrigerator door 120.

In one embodiment, the display 210 (e.g., an OLED display) may comprise a touchscreen interface such that a user is able to activate the camera matrix 130 by touching the display 210, or alternatively only activate a portion of the camera matrix 130 corresponding to, for example, the area associated with where the display 210 was contacted.

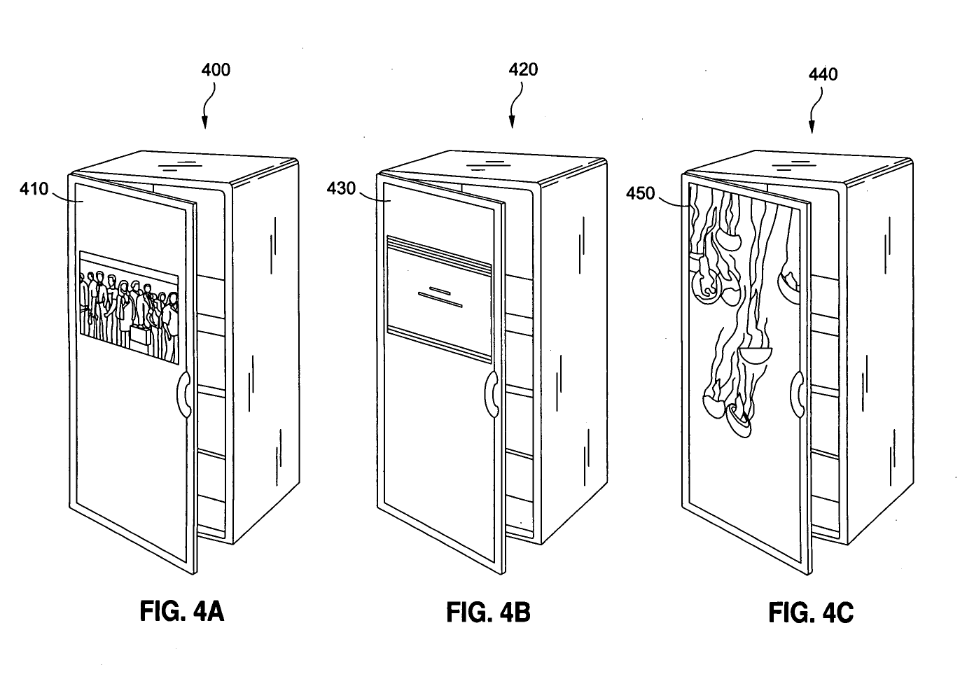

It should further be appreciated that the display 210 may be networked or directly connected to a multimedia processing system so as to be able to also display television broadcast images, Internet content, or the like. While the details of such multimedia processing systems are known in the art and beyond the scope of this disclosure, it should be appreciated that the display 210 may include one or more digital or analog inputs for receiving such broadcast or Internet-based content. Additionally, the display 210 may be equipped with inputs for directly uploading image data (e.g., jpeg, mpeg, etc.). This may enable user's to display pictures across the exterior of the refrigerator 100 as if they were pinned up magnets, pins, etc. Similarly, and as will be described in more detail below with reference to FIGS. 4A-4C, the image data may comprise patterns or shapes such that the exterior of the refrigerator 100 may aesthetically match or conform to any kitchen decor.

Upon touching or otherwise activating the display 210, video imagery of the refrigerator's 100 content may be displayed to the user. Alternatively, only a snapshot or still image may be taken and displayed to the user. When video imagery is provided, a light source may be illuminated during such time. When a still image is taken, the light source may only come on at such time, thereby functioning as a sort of “flash” for the camera matrix 130. Since taking and processing the image data may not occur instantly, in certain embodiments, the camera matrix 130 may be set to automatically take image data at a predetermined time, such as shortly after the refrigerator door 120 has been closed.

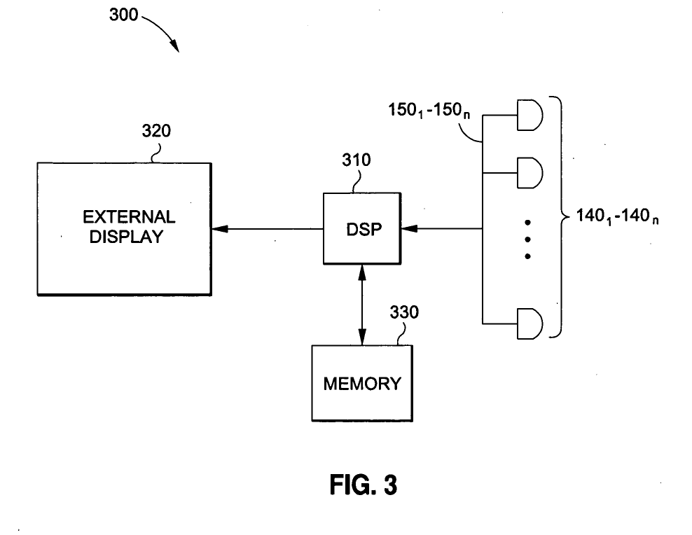

Referring now to FIG. 3, depicted is a block diagram of a system 300 comprised of various components utilized in one embodiment of the invention. In particular, system 300 comprises the plurality of individual cameras 140₁-140ₙ which are electrically interconnected via connections 150₁-150ₙ to form the camera matrix 130 of FIG. 1A. System 300 further comprises a digital signal processor (DSP) 310 (or processing equivalent) for receiving the image data from the plurality of individual cameras 140₁-140ₙ. It should be appreciated that the DSP 310 may be implemented as an application specific integrated circuitry (ASIC), Field Programmable Gate Array (FPGA) circuitry, or the like. In one embodiment, the DSP 310 may be adapted to receive the image data from the plurality of individual cameras 140₁-140ₙ, detect the lines of image overlap, stitch or combine the image data together along these lines, and provide seamless, combined image data to an external display 320 (e.g., display 210 of FIG. 2).

System 300 further comprises a memory 330, which may include one or both of volatile and non-volatile computer memory. In one embodiment, the memory 330 may be used to buffer incoming image data from the plurality of individual cameras 140₁-140ₙ while the DSP 310 is processing (e.g., analyzing and stitching) the received image data. Additionally, the memory 330 may be coupled to a digital or analog input (not shown) for receiving external image data (e.g., jpeg files, mpeg files, etc.). In addition, memory 330 may be used to store any information that would be desirable to display on the exterior of the application, such as storing recipes in a virtual cookbook that could be accessed from and displayed on the external display 320 (which may comprise a touchscreen).

It should further be appreciated that memory 330 may include software code for any number of applications, such as inventory management software for tracking what is in the appliance, stylus support for writing quick notes anywhere on the exterior of the appliance, music support including external “visualizers”, or even full motion screensavers (e.g., fishtanks, overlays, animations, etc.). Additionally, the system 300 may be further configured with any known network interface and/or a television tuner adapted for receiving and decoding broadcast content. In this fashion, display 320 similarly may be used to receive and browse Internet content, as well as to present broadcast content.

Referring now to FIGS. 4A-4C, depicted are various images that may be displayed on the exterior of an appliance which is configured in accordance with the principles of the invention. In particular, FIG. 4A depicts a refrigerator 400 (e.g., refrigerator 100) configured with an external display 410 (e.g., OLED touchscreen) displaying broadcast television content. FIG. 4B depicts a refrigerator 420 (e.g., refrigerator 100) also configured with an external display 430 (e.g., OLED touchscreen), but this time displaying Internet-based content. Finally, FIG. 4C depicts a refrigerator 440 (e.g., refrigerator 100) also configured with an external display 450 (e.g., OLED touchscreen) in which an animated screensaver is being displayed. Similarly, it should be appreciated that any type of desired pattern or color scheme may be displayed, such as to match the decor of the refrigerator's surroundings.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A system for providing seamless imaging of appliance interiors comprising:
an appliance;
a camera matrix disposed on at least one interior surface of the appliance, the camera matrix including a plurality of electrically interconnected cameras;
a display disposed on an exterior surface of the appliance; and
a processor electrically connected to the camera matrix and the display, wherein the processor is adapted to,
receive individual image data from the plurality of electrically interconnected cameras,
generate combined image data from said received individual image data, and
provide said combined image data to the display.

2. The system of claim 1, wherein the appliance is a refrigerator.

3. The system of claim 1, wherein the at least one interior surface comprises an interior of an appliance door.

4. The system of claim 1, wherein the exterior surface of the appliance is an exterior of an appliance door.

5. The system of claim 4, wherein the display extends across and displays the combined image data on between 50% and 95% of the exterior of the appliance door.

6. The system of claim 1, wherein the camera matrix is disposed on a rear interior surface of the appliance oriented opposite to a door on the appliance.

7. The system of claim 1, wherein the display is integrated with the exterior surface, and wherein the exterior surface corresponds to an exterior of a door on the appliance.

8. The system of claim 1, wherein the display includes touchscreen technology to receive one or more user inputs.

9. The system of claim 1, wherein the individual image data received from the plurality of electrically interconnected cameras comprises one of video data and still image data.

10. The system of claim 1, wherein the processor is further configured to generate the combined image data from the received individual image data by detecting lines of image overlap in the received individual image data, and stitching said individual image data together along said detected lines to generate the combined image data.

11. The system of claim 1, wherein the combined image data is overlapping field of view data.

12. The system of claim 11, wherein the overlapping field of view data, when presented by the display, creates a see-through effect on the exterior surface of the appliance.

13. The system of claim 1, further comprises a memory electrically connected to the processor, and wherein the processor is further configured to execute instruction sequences stored in the memory, and wherein said instruction sequences correspond to at least one of an inventory management software application, a music player application, a screensaver application and an Internet browser application.

14. A method for providing seamless imaging of an appliance's interior comprising the acts of:
disposing a camera matrix on at least one interior surface of the appliance, wherein the camera matrix includes a plurality of electrically interconnected cameras;
disposing a display on an exterior surface of the appliance;
receiving individual image data from the camera matrix;
generating combined image data from said received individual image data; and
displaying said combined image data on the display.

15. The method of claim 14, wherein the appliance is a refrigerator.

16. The method of claim 14, wherein disposing the camera matrix comprises disposing the camera matrix on an interior of an appliance door.

17. The method of claim 14, wherein disposing the display comprises disposing the display on an exterior of an appliance door.

18. The method of claim 17, wherein disposing the display comprises disposing the display across between 50% and 95% of the exterior of the appliance door.

19. The method of claim 14, wherein disposing the camera matrix comprises disposing the camera matrix on a rear interior surface of the appliance oriented opposite to a door on the appliance.

20. The method of claim 14, wherein disposing the display comprises integrating the display with the exterior surface, and wherein the exterior surface corresponds to an exterior of a door on the appliance.

21. The method of claim 14, further comprising receiving one or more user touchscreen inputs by said display.

22. The method of claim 14, wherein receiving individual image data from the camera matrix comprises receiving one of video data and still image data from the plurality of electrically interconnected cameras.

23. The method of claim 14, wherein generating the combined image data comprises detecting lines of image overlap in the received individual image data, and stitching said individual image data together along said detected lines to generate the combined image data.

24. The method of claim 14, wherein the combined image data is overlapping field of view data.

25. The method of claim 24, wherein displaying the overlapping field of view data on the display creates a see-through effect on the exterior surface of the appliance.
